(19) United States
(12) Patent Application Publication
(10) Pub. No.: US 2015/0113662 A1
(43) Pub. Date: Apr. 23, 2015

(54) Backup System for enhancing the security of information technological control facilities

(71) Applicant: Siegfried Müller, Dinkelsbuhl (DE)

(72) Inventor: Siegfried Müller, Dinkelsbuhl (DE)

(73) Assignee: MB connect line GmbH Fernwartungssysteme, lIsfeld (DE)

(21) Appl. No.: 14/513,489

(22) Filed: Oct. 14, 2014

(30) Foreign Application Priority Data
Oct. 17, 2013 (DE) 20 2013 104 690.6

(51) Int. Cl. G06F 21/50; G05B 15/02

(52) U.S. Cl. CPC G06F 21/50; G05B 15/02
USPC 726/26

(57) ABSTRACT

A backup device (100) is adapted to conduct a backup of a control device (200), with an interface (104), which may be coupled with the control device (200); a transmission unit (102), adapted to read data from the control device (200) via the interface (104) and/or write data to the control device (200) via the interface (104); a memory unit (108, 116), adapted to store the data read from the control device (104); a backup control unit (102) adapted to instruct the transmission unit (102), to read at least part of a program memory (208) of the control device (200) as first program backup data (120), and to instruct the memory unit (108, 116) to store the first program backup data (120) in a non-volatile way, wherein the backup control unit (102) is further adapted to instruct the transmission unit (202) to read at least part of a program memory (208) of the control device (200) as further program backup data (122, 122a); a comparison unit (102) adapted to compare the first program backup data (120) and the further program backup data (122, 122a); and a warning unit (102) adapted to release a warning, if the comparison unit (102) determines that the first program backup data (120) and the further program backup data (122, 122a) differ.

### CROSS-REFERENCE TO RELATED APPLICATION(S)

This application claims the benefit of DE Patent Application No. DE 20 2013 104 690.6, filed Oct. 17, 2013 (17 Oct. 2013), the entirety of which is hereby incorporated herein by reference.

### BACKGROUND OF THE INVENTION

1. Field of the Invention

The present invention relates to backup devices.

### SUMMARY OF THE INVENTION

The invention relates to a backup device, which may conduct a backup of a control device, for instance a memory programmable control. The backup comprises backup of the data and/or of the program of the control device. Further, a memory image of the control device may be backed up. Such backups are commonly denoted as “backup” by the skilled person.

The backup device may further determine, whether the program stored in the control device was manipulated, for instance in having been altered by computer viruses.

The control device may be memory programmable control (SPS). Such a memory programmable control may control a facility, for instance a production line or a chemical reactor. Such a memory programmable control usually does not comprise backup means, in order to backup program data and other stored data. Thus, an external device is required, in order to create a data backup, for instance by copying the data of the memory programmable control.

Further, it is not possible to install in the memory programmable control programs, which may identify any manipulations and/or which may identify virus contamination, since, usually, no standard operating systems are used in memory programmable controls.

It is an object of the invention to provide a backup device, which allows a testing whether the program data of a control device were manipulated.

The object of the invention is solved by a backup device according to claim 1. The dependent claims claim preferred embodiments.

A backup device according to the invention, which is adapted to conduct a backup of a control device comprises an interface, which may be coupled with the control device, and a transmission unit, adapted to read data from the control device and/or write data to the control device via the interface. The control device may be a control device for controlling a production line or a chemical reactor. In particular, the control device may be memory programmable control or similar. Further, the control device comprises a memory unit, adapted to store the data read from the control device. It is understood that the memory unit can store the data in a non-volatile way, for instance by means of a hard drive, a tape, or an EPROM.

The backup device further comprises a backup control unit adapted to instruct the transmission unit to read at least a part of a program memory of the control unit as first program backup data, and to instruct the memory unit to store the first program backup data in a non-volatile way. The program memory of the control device can be a program, which controls the facility, for instance the production line or the chemical reactor. The program memory can store the instructions of the processor of the control device. The control unit is adapted to instruct the transmission unit to read at least a part of a program memory of the control device as further program backup data. The program backup data may be a data backup, i.e. a so called backup.

The first program backup data may for instance be backed up after successful initial operation or approval. The further program backup data may be obtained by means of a so called cyclic data backup.

The backup device further comprises a comparison unit adapted to compare the first program backup data and the further program backup data. If the first program backup data and the further program backup data are compared, it is possible to identify manipulations in the program memory or the control device, for instance by computer viruses. The backup device further comprises a warning unit, adapted to release a warning, if the first program backup data and the further program backup data differ.

Thereby, the operator of the control device may recognize that the program memory of the control device was manipulated.

The backup control unit may be adapted to instruct the transmission unit to write the first program backup data to the program memory of the control device, if the comparison unit determines that the first program backup data and the further program backup data differ. Thereby it can be ensured that in the program memory of the control device a non-manipulated program is present.

The backup device may comprise an input unit, by use of which the user may confirm that the first program backup data are to be written to the program memory of the control unit, wherein the backup control unit is adapted to instruct the transmission unit to write the first program backup data to the program memory of the control device, if the user confirms by means of the input unit that the first program backup data is to be written to the program memory of the control unit. By this arrangement, an interaction of the user is interposed before the program memory of the control unit is overwritten with the original program, again. Thereby, it is possible to ensure that intended alterations in the program memory of the control unit are not overwritten by the original contents of the program memory.

The warning unit may release the warning as an e-mail, SMS, by means of a signal at a digital outlet and/or by means of a relay.

The comparison unit can identify a manipulation to the program code of the control unit and/or the contamination by computer viruses in the program code of the control unit.

The control backup unit may be adapted to instruct the transmission unit to read at least a part of dynamic memory of the control device as dynamic backup data, and to instruct the memory unit to store the dynamic backup data in a non-volatile way. In the dynamic memory of the memory programmable control, data such as formulations, nominal values etc. are deposited. Such values are constantly altered and optimized by machine operators. For the most part, these alterations are not sufficiently documented.

The interface may comprise an Ethernet interface, and MPI interface and/or a Profibus interface. The functionality of these interfaces are known to the skilled person and do not have to be further explained herein.

The backup device may comprise a timer adapted to instruct the backup control unit after lapse of a predetermined time interval to read at least a part of the program memory of the control device as further program backup data from the control device, to instruct the comparison unit, to compare the first program backup data with the further program backup data, and to instruct the warning unit to release a warning, if the first program backup data and the further program backup data differ.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a diagram that shows one embodiment of the invention.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

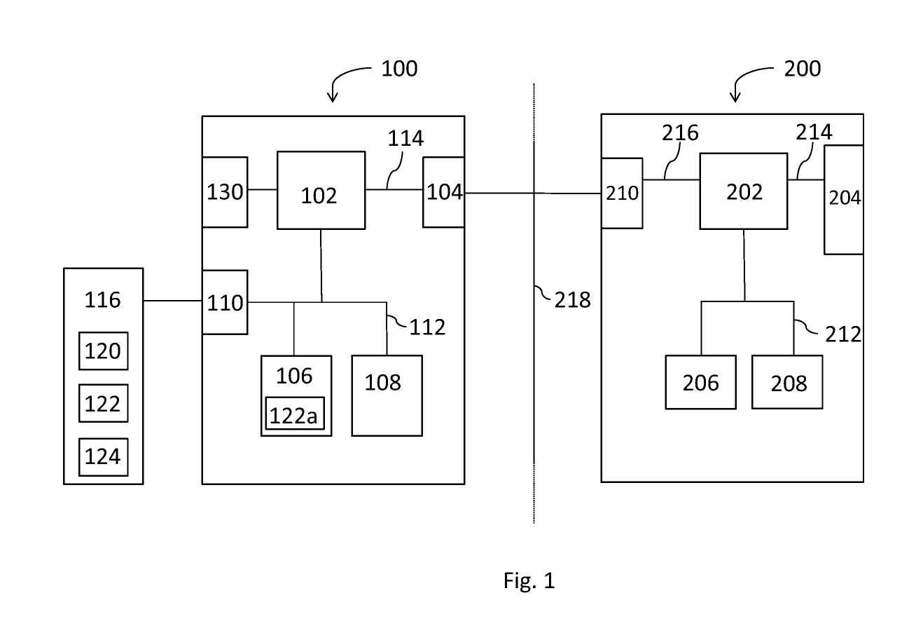

The invention is now described with reference to FIG. 1, which shows an exemplary and non-limiting embodiment of the invention.

FIG. 1 shows a memory programmable control 200 and a backup device 100, which are connected via a data connection 218. The data connection 218 can be a bus, for instance a Profibus, an MPI-bus or an Ethernet. The memory programmable control comprises a processor 202, a working memory 206 and a first bus 212, which connects the working memory 206 and the program memory 208 with the processor 202. The working memory 206 may be a volatile memory, such as for instance a RAM. The program memory 208 may be a non-volatile memory, for instance a hard drive or an EPROM. The program memory may store the instructions, which are to be executed by the processor 202, in order to control a facility, for instance a production line or a chemical reactor.

To the processor 202 of the control unit 200 a first interface 204 is connected via a second bus, through which a unit, which is to be controlled, may be connected. The interface 204 may comprise binary outlets, digital outlets, relays, and/or a bus. Via a third bus 216, a second interface 210 is connected to the processor 202. The second interface 210 may be used for controlling an external unit. Likewise, the second interface 210 may be used for a connection to a higher ranking computer, for instance a line computer or a cell computer. The functionality of memory programmable controls is known to the skilled person and, in terms of conciseness, does not have to be further explained at this stage.

The backup device according to the invention comprises a processor 102, which is connected by means of a first bus 112 to a working memory 106 and a non-volatile memory 108 as well as a first interface 110. The volatile memory 106 may comprise the working memory and for instance be formed by a RAM. The non-volatile memory 108 may comprise the program memory. A backup medium 116 may be connected to the first interface 110. The backup medium may comprise a tape drive, a mobile hard drive, and/or an EPROM. The first interface 110 may be for instance a USB interface.

The backup device further comprises a second interface 104, which is connected to the processor by means of a second bus 114. The second interface may be a Profibus, an MPI bus or an Ethernet. The processor 102 may be a transmission unit, a comparison unit, and/or a timer.

In the following, the functionality of the invention is briefly explained. Subsequent to the initial operation, the processor 102 of the backup device 100 requests, via the interface 104, the data connection 218 as well as the interface 210, that the processor 202 of the memory programmable control 200 transfers the content of the program memory 208. The processor 102 of the backup device 100 may store the content of the program memory 208 either in the non-volatile memory 108 or in the external memory unit 116 as first program backup data 120.

After lapse of a predetermined time interval, which is recognized by the processor 102 of the backup device 100, as it also functions as timer, the processor 102 of the backup device 100 requests again that the processor 202 of the control device 200 transfers the content of the program memory 208. This data is treated by the processor 102 of the backup device 100 as further program backup data and may be stored as further program backup data 122, 122a in the external memory unit 116 or in the non-volatile memory 108.

It is not required that the further program backup data 122 are stored to the external memory unit 116. The further program backup data may be stored in the volatile memory 106 of the backup device. This arrangement is preferred such that possibly manipulated program backup data may not distribute.

The processor 102 of the backup device 100 may function as comparison unit and compare the first program backup data 120 and the further program backup data 122, 122a. If the first program backup data 120 and the further program backup data 122, 122a differ, the program memory 208 of the control device was manipulated, for instance by computer viruses. In this case, the processor 102 of the backup device 100 releases an alarm on a third interface 130, for instance by means of e-mail, SMS, or a binary signal or such. The third interface may be a modem.

The processor 102 of the backup device 100 may instruct the processor 202 of the control device 200 to transfer the content of the dynamic memory 206. The processor 102 of the backup device 100 stores this data as dynamic backup data 124 in the external memory unit 116 or in the non-volatile memory 108 of the backup device.

The present invention has the advantage that, on the one hand, backups of a memory programmable control may be conducted and, on the other hand, manipulations in the program code, for instance by computer viruses, may be identified.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A backup device, adapted to conduct a backup of a control device, comprising:
an interface, which may be coupled with the control device;
a transmission unit, adapted to read data from the control device via the interface and/or write data to the control device via the interface;
a memory unit, adapted to store the data read from the control device;
a backup control unit adapted to instruct the transmission unit, to read at least part of a program memory of the control device as first program backup data, and to instruct the memory unit to store the first program backup data in a non-volatile way, wherein the backup control unit is further adapted to instruct the transmission unit to read at least part of a program memory of the control device as further program backup data;
a comparison unit adapted to compare the first program backup data and the further program backup data; and
a warning unit adapted to release a warning, if the comparison unit determines that the first program backup data and the further program backup data differ.

2. The backup device according to claim 1, wherein the backup control unit is adapted to instruct the transmission unit to write the first program backup data to the program memory of the control device, if the comparison unit determines that the first program backup data and the further program backup data differ.

3. The backup device according to claim 2, further comprising an input unit, by means of which a user may confirm that the first program backup data are to be written to the program memory of the control device, wherein the backup control unit is adapted to instruct the transmission unit, to write the first program backup data to the program memory of the control device, if the program backup data and the further program backup data differ and if the user confirms by means of the input unit that the first program backup data are to be written to the program memory of the control device.

4. The backup device according to claim 1, wherein the warning unit is adapted to release the warning via e-mail, via SMS, a digital outlet and/or via a relay.

5. The backup device according to claim 1, wherein the comparison unit is adapted to determine manipulation to the program code of the control device and/or contamination by computer viruses in the program code of the control device.

6. The backup device according to claim 1, wherein the backup control unit is adapted to instruct the transmission unit to read at least a part of a dynamic memory of the control device as dynamic backup data, and to instruct the memory unit to store the dynamic backup data in a non-volatile way.

7. The backup device according to claim 1, wherein the interface comprises an Ethernet interface, MPI interface, and/or a Profibus interface.

8. The backup device according to claim 1, further comprising a timer adapted to instruct the backup control unit to read, after lapse of a predetermined time interval, at least a part of the program memory of the control device as further program backup data from the control device, to instruct the comparison unit to compare the first program backup data with the further program backup data, and to instruct the warning unit to release a warning, if the first program backup data and the further program backup data differ.
